(19) United States
(12) Patent Application Publication
(10) Pub. No.: US 2008/0306792 A1
(43) Pub. Date: Dec. 11, 2008

(54) Brokerage service method and system using human networking

(75) Inventor: Myong Jong Lee, Sungnam-si (KR)

Correspondence Address: MCDERMOTT WILL & EMERY LLP, 600 13TH STREET, N.W., WASHINGTON, DC, 20005-3096, US

(73) Assignees: SAMJIN LND CO., LTD.; MYUNG JONG LEE

(21) Appl. No.: 12/155,585

(22) Filed: Jun. 6, 2008

(30) Foreign Application Priority Data
Jun. 8, 2007 (KR) 10-2007-0056173

(51) Int. Cl. G06F 9/44

(52) U.S. Cl. 705/7

(57) ABSTRACT

Provided is a brokerage service method and system using human networking that can quickly provide a user with information or service that the user desires and also can improve reliability of the provided information or service. The present invention is constructed to repeat operations of receiving, from a user, a request for information or service that the user desires, and contact information of a possible information/service provider that the user is aware of, transferring the request to the possible information/service provider, obtain a positive response for the request or contact information of another possible information/service provider, and transferring the request to the other possible information/service provider, and thereby to transfer the request of the user based on human networking and to connect a corresponding possible information/service provider with the user when a positive answer is received.

### CROSS-REFERENCE TO RELATED APPLICATION

This application claims the benefit of Korean Patent Application No. 10-2007-0056173, filed on Jun. 8, 2007, in the Korean Intellectual Property Office, the disclosure of which is incorporated herein by reference.

### BACKGROUND OF THE INVENTION

1. Field of the Invention

The present invention relates to a brokerage service method and system using human networking that can relay information or services using personal human networking.

2. Description of Related Art

Generally, when people need information such as employment information, contents, and the like, or when people desire to use a service, they may ask their acquaintance or may obtain desired information from books, newspaper, advertisements and the like, that are provided to offer various types of information.

However, in the case of the conventional information obtaining method, it generally takes long time to procure the desired information. Also, there is some constraint on collecting information. Therefore, it may be difficult to obtain accurate information.

Currently, as the Internet is becoming widespread, many people are using Internet search services to obtain information.

When obtaining information via the Internet, it may be difficult to accurately and quickly obtain desired information due to a large amount of information and a large number of services provided via the Internet. Also, even when desired information or service is retrieved using the Internet search service, the information can not be trusted because it has been provided by anonymous users.

### BRIEF SUMMARY

An aspect of the present invention provides a brokerage service method and system using human networking that can quickly provide a user with desired information or service and also can improve reliability of the information or the service.

According to an aspect of the present invention, there is provided a brokerage service method using human networking, the method including: receiving, from a user, a request for information or service that the user desires and contact information of a first possible information/service provider; transferring the request to the first possible information/service provider based on the contact information; connecting the first possible information/service provider with the user when a positive answer is received from the first possible information/service provider in response to the request; and repeatedly transferring the request to a second possible information/service provider every time contact information of the second possible information/service provider is received from the first possible information/service provider in response to the request.

According to another aspect of the present invention, there is provided a brokerage service system including: a request receiver configured to receive, from a user, a request for information or service that the user desires; a request brokerage unit configured to 1) obtain either contact information of a first possible information/service provider from the user or contact information of a another second possible information/service provider from the first possible information/service provider, and 2) to transfer the request of the user based on the obtained contact information; and a connection unit configured to connect, with the user, the first possible information/service provider or the another second possible information/service provider that transmits a positive answer with respect to the request, wherein the request brokerage unit is configured to repeatedly transfer the request to the second possible information/service provider based on contact information of second information/service provider every time the contact information of the second possible information/service provider is received from the first possible information/service provider.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a network structure enabling a brokerage service using human networking according to an embodiment of the present invention;

FIG. 2 is a flowchart illustrating a brokerage service method using human networking according to an embodiment of the present invention;

FIGS. 3A through 3D illustrate a brokerage service process according to an embodiment of the present invention; and

FIG. 4 is a block diagram illustrating a configuration of a brokerage service system according to an embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The term “possible information/service provider (first possible information/service provider)” used throughout the present specification may denote a predetermined user that receives a request for information or service that a user desires from the user, for example, another user that the user generating the request has been acquainted with.

Also, the term “another possible information/service provider (second possible information/service provider” may denote still another user whose contact information is provided by the “possible information/service provider (first possible information/service provider)” and thereby that receives the request.

Accordingly, the request of the user may be widely spread to a plurality of users via “possible information/service provider (first possible information/service provider)” or “another possible/service provider (second possible information/service provider).

For example, a first entity whose contact information is provided by the user may correspond to “possible information/service provider (first possible information/service provider)”. A second entity whose contact information is provided by the first entity, “possible information/service provider (first possible information/service provider)” may correspond to “another possible/service provider (second possible information/service provider)”. A brokerage service model using human networking according to the present invention may provide the request for the first and second entities.

Also, in a case where contact information is provided by the second entity receiving the request, the second entity may be determined as “possible information/service provider (first possible information/service provider)”. In this case, the brokerage service model using human networking according to the present invention may transfer the request to a third entity corresponding to “another possible/service provider (second possible information/service provider) whose the contact information is provided by the second entity.

When contact information is provided by “possible information/service provider (first possible information/service provider), the above-described process of transferring the request may be continuously repeated.

When it is determined detailed description related to a related known function or configuration they may make the purpose of the present invention unnecessarily ambiguous in describing the present invention, the detailed description will be omitted here.

In the present specification, the expression “an object is connected with another object” includes a case where the object is directly connected with the other object and a case where the object is indirectly connected with the other object via still another object between them. Also, the expression “includes/including a predetermined component” indicates “it is possible to further include another component, instead of excluding the component, as long as there is no particular opposing description thereto”.

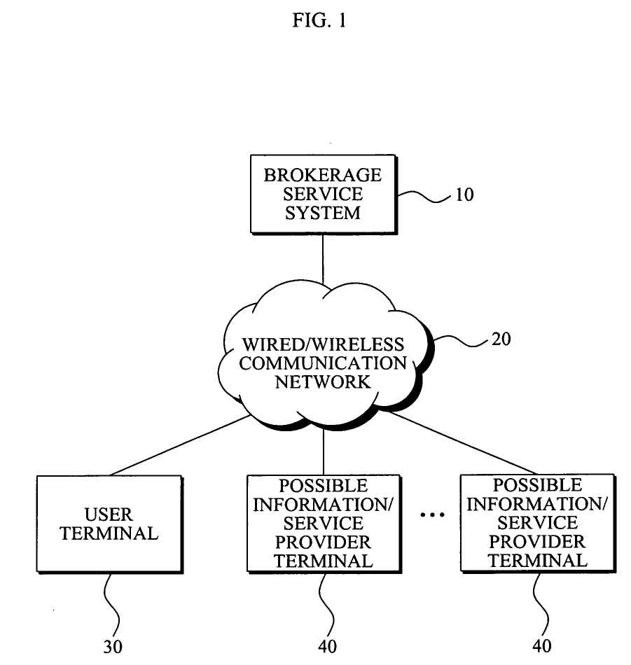

FIG. 1 illustrates a network structure enabling a brokerage service using human networking according to an embodiment of the present invention.

Referring to FIG. 1, a brokerage service system 10 denotes a system that may provide a brokerage service using human networking. A wired/wireless communication network 20 denotes a network that may access the brokerage service system 10, or may enable the brokerage service system 10 to transfer a message or data. A user terminal 30 denotes a terminal of a user that may receive a brokerage service associated with information or a service from the brokerage service system 10 via the wired/wireless communication network 20. A possible information/service provider terminal 40 denotes a terminal of a user that may provide an information or service request of the user terminal 30 via the brokerage service system 10.

The wired/wireless communication network 20 may adopt any type of communication network that enables transmitting of a message or data and is embodied using a wired/wireless scheme. For example, the wired/wireless Internet and/or a mobile communication network may be used for the wired/wireless communication network 20.

The user terminal 30 and the possible information/service provider terminal 40 may use any type of terminal devices that can access the brokerage service system 10 via the wired/wireless communication network 20 to transmit and receive data. For example, a personal computer (PC), a mobile communication terminal such as a personal digital assistant (PDA) and a mobile phone, and the like may be used for the user terminal 30 and the possible information/service provider terminal 40.

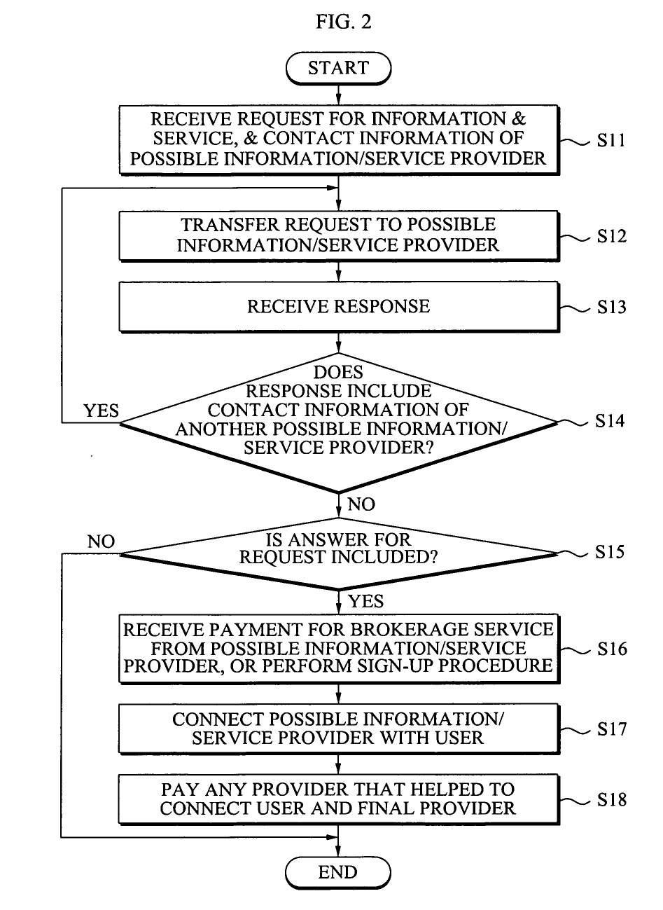

FIG. 2 is a flowchart illustrating a brokerage service method using human networking according to an embodiment of the present invention. According to the present invention, the brokerage service method may be performed by the brokerage service system 10 of FIG. 1.

Hereinafter, the brokerage service method using human networking will be described with reference to FIG. 2.

In operation S11, the brokerage service system 10 may receive, from a user terminal of the user, a request for information or service that a user desires and contact information of a possible information/service provider.

The contact information of the possible information/service provider may be contact information of acquaintances that the user is currently acquainted with. Also, the contact information may be used to communicate with acquaintances that are likely to provide the desired information or service, or to be aware of the desired information or service. Also, the contact information may be used to communicate with a broking computer system. For example, the contact information may include an electronic mail (e-mail) address of the possible information/service provider, a mobile phone number of the possible information/service provider, and the like. The contact information may be any type of information that can identify each possible information/service provider and communicate with the possible information/service provider via a wired/wireless communication network.

In operation S12, the brokerage service system 10 may transfer the received request to the possible information/service provider based on the received contact information. For example, when the contact information of the possible information/service provider is an e-mail address, the brokerage service system 10 may send an e-mail including the request to the e-mail address as a destination address. When the contact information is a mobile phone number, the brokerage service system 10 may convert the request to a text message and transmit the text message to the mobile phone number. A scheme of transferring the request of the user to the possible information/service provider may not be limited to a scheme of using the e-mail address or using the text message. Any scheme of automatically transferring a user request may be used.

When transmitting the request, the brokerage service system 10 may provide the requested information or service. Also, the brokerage service system 10 may request contact information of another possible information/service provider that can provide the requested information or service.

According to an aspect of the present invention, in order to manage a brokerage service status associated with the requested information or service request, the brokerage service system 10 may store and manage the received request and information associated with a possible information/service provider that substantially transfers the request.

In operation S13, the brokerage service system 10 may receive a response from a terminal of the possible information/service provider in response to the request.

The response may include a positive answer with respect to providing of the requested information or service, or contact information of another possible information/service provider that the possible information/service provider is aware of.

In operation S14, the brokerage service system 10 may verify whether the response includes the contact information of the other possible information/service provider. When the response includes the contact information, the brokerage service system 10 may perform again operation S12 based on the contact information.

By repeating operations S12 through S14, the brokerage service system 10 may spread the request of the user to a plurality of possible information/service providers. Specifically, the brokerage service system 10 may transfer the request to the possible information/service provider that the user is aware of and also transfer the request to another possible information/service provider that the possible information/service provider is aware of. As described above, the request of the user for the information or service may be transferred based on human networking.

During the spreading process, when there is a possible information/service provider that may provide the information or service requested by the user, the possible information/service provider may transmit a positive answer with respect to the information or service.

In operation S15, the brokerage service system 10 may determine whether the positive answer for the request is included in the received response. When the positive answer is included, the brokerage service system 10 may receive a payment for a brokerage service associated with the information or service request from a possible information/service provider (call it as “answering provider”) that transmits the positive answer in operation S16. The payment for the brokerage service may be made by paying a certain amount of money or anything that can be substituted for an equal value of money. Also, the payment for the brokerage service may be made by being assigned with a right that allows providing a third party with information associated with the possible information/service provider transmitting the positive answer, i.e. the answering provider, through a sign-up procedure.

In operation S17, when the payment is received from the possible information/service provider transmitting the positive answer, i.e. the answering provider, the brokerage service system 10 may provide the answering provider with user information, for example, contact information of the user, subsequently connecting the answering provider with the user.

According to an aspect of the present invention, at least one another possible information/service provider may be involved in connecting the possible information/service provider with the user. Specifically, the request may be transferred to the connecting the possible information/service provider in such a manner that the at least one other possible information/service provider provides contact information of the possible information/service provider.

In operation S18, the brokerage service system 10 may pay the at least one other possible information/service provider that is involved in transferring the request to the connecting possible information/service provider (answering provider).

Through this, it is possible to induce active participation of many possible information/service providers with respect to a requested information or service. Since a request can be spread wider and distributed by the possible information/service providers, it is possible to more quickly connect a possible information/service provider with the user.

In the present embodiment, the possible information/service provider pays for the brokerage service, but the present invention is not limited thereto. Reverse scenario can be possible. Specifically, it is possible to make the user pay for the brokerage service and pay the possible information/service provider for providing of information or service.

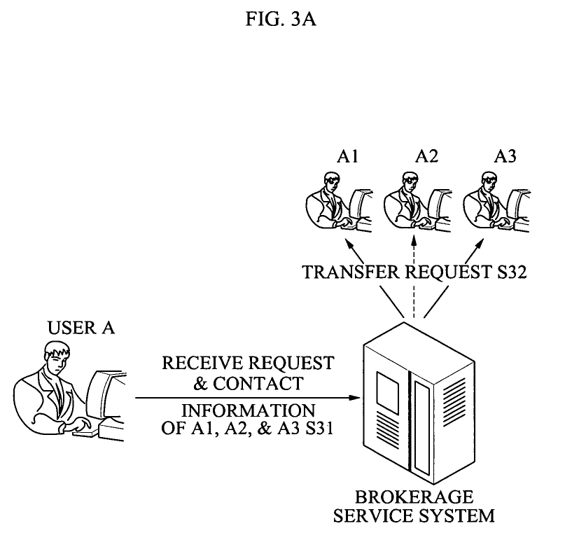

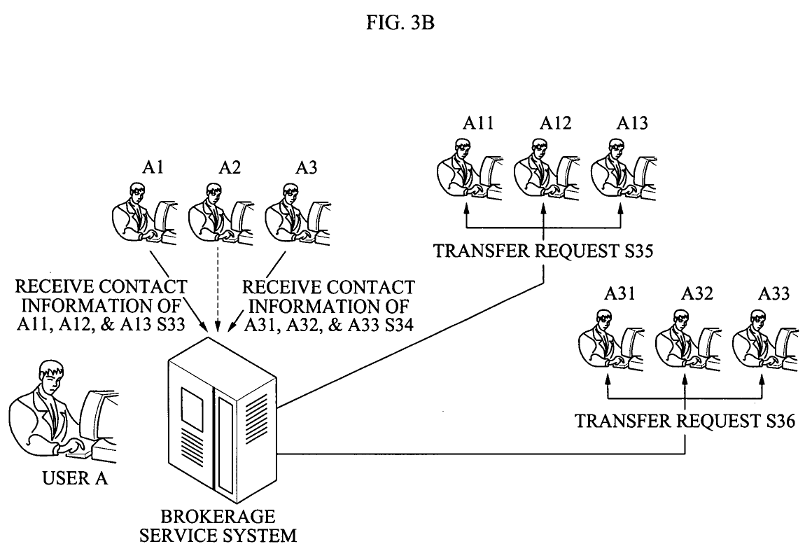

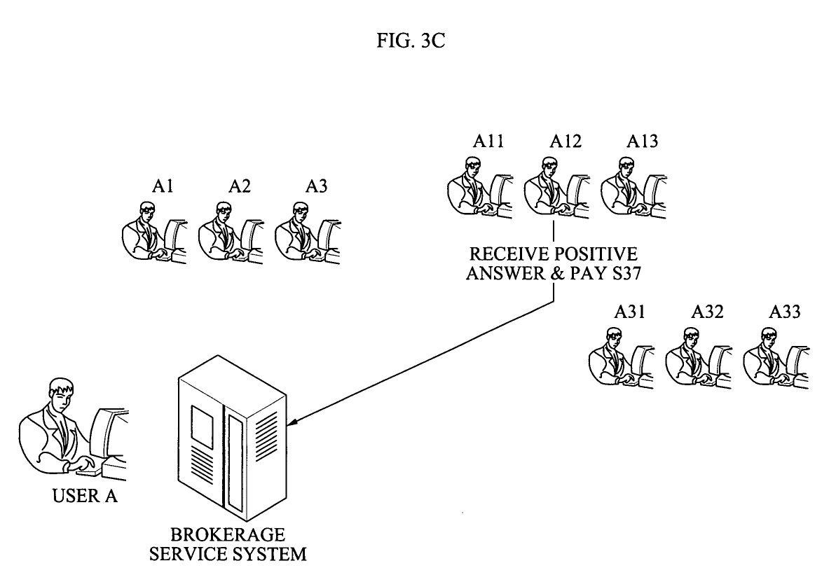

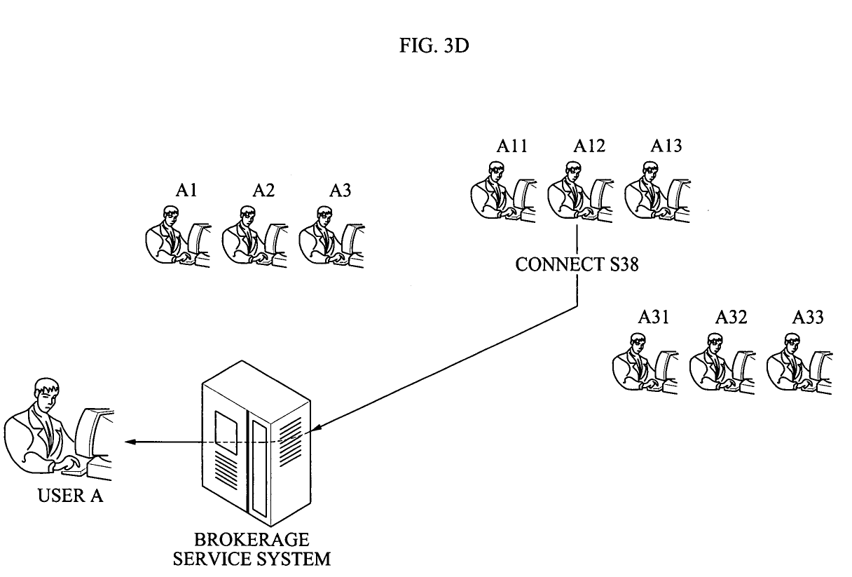

Hereinafter, a brokerage service process according to an embodiment of the present invention will be described in detail with reference to FIGS. 3A through 3D.

Referring to FIG. 3A, in operation S31, user A may transfer, to a brokerage service system, a request for information or service that the user A desires, and contact information of acquaintances A1, A2, and A3 that the user A is acquainted with. Here, the acquaintances A1, A2, and A3 may be possible information/service providers. In operation S32, the brokerage service system may transfer the request of the user A to the possible information/service providers A1, A2, and A3 based on the received contact information. As described above, according to an aspect of the present invention, the request of the user A may be transferred using human networking of the user A. When transferring the request, the brokerage service system may request the possible information/service providers A1, A2, and A3 for providing of the requested information or service. When the possible information/service providers A1, A2, and A3 may not provide the requested information or service, the brokerage service system may request contact information of another possible information/service providers that the possible information/service providers A1, A2, and A3 are aware of.

Referring to FIG. 3B, in operations S33 and S34, the brokerage service system may receive contact information of another possible information/service providers A11, A12, and A13, and A31, A32, and A33 from A1 and A3 that the possible information/service providers A1 and A3 are aware of in response to the request. In operations S35 and S36, the brokerage service system may transfer the request of the user A to the other possible information/service providers A11, A12, A13, A31, A32, and A33 based on the received contact information. Through this, the request of the user A may be transferred to many people.

Referring to FIG. 3C, in operation S37, the brokerage service system may receive a positive answer with respect to the request from the possible information/service provider A12 among the other possible information/service providers A11, A12, A13, A31, A32, and A33. In this case, the possible information/service provider A12 may pay a predetermined amount of charge.

Referring to FIG. 3D, in operation S38, the brokerage service system may connect the user A with the possible information/service provider A12 transmitting the positive answer, to provide the requested information or service.

As described above, according to an aspect of the present invention, it is possible to transfer a request for information or service that a user desires to reliable acquaintances and subsequently relay the requested information or service, instead of randomly transmitting the request to a plurality of anonymous users. Therefore, it is possible to quickly provide the user with accurate information or service.

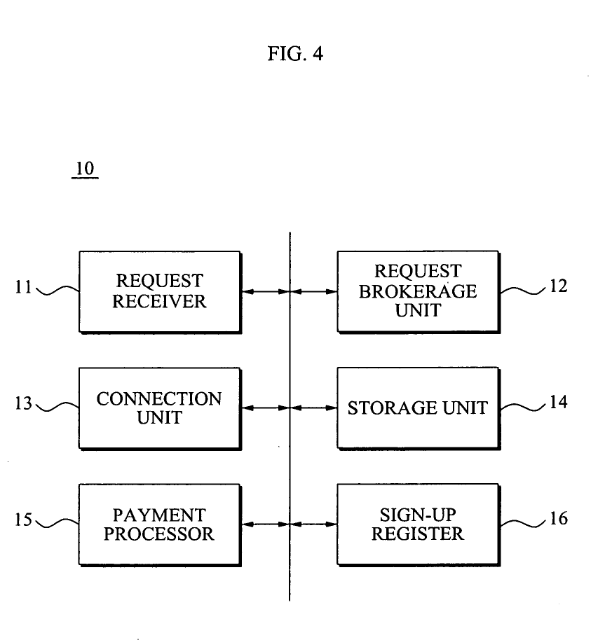

FIG. 4 is a block diagram illustrating a configuration of a brokerage service system 10 according to an embodiment of the present invention.

Referring to FIG. 4, the brokerage service system 10 may include a request receiver 11, a request brokerage unit 12, a connection unit 13, a storage unit 14, a payment processor 15, and a sign-up register 16. The request receiver 11 may receive, from the user, a request for information or service that the user desires. The request brokerage unit 12 may obtain either contact information of a possible information/service provider from the user or contact information of another possible information/service provider from the possible information/service provider. Also, the request brokerage unit 12 may transfer the request based on the obtained contact information. The connection unit 13 may connect, with the user, the possible information/service provider that transmits a positive answer with respect to the request. The storage unit 14 may store the request or brokerage information associated with the request. The payment processor 15 may receive a payment for a brokerage service from the user or the possible information/service provider in association with a connection between the user and the possible information/service provider. Also, the payment processor 15 may pay the possible information/service provider for providing of information. The sign-up register 16 may perform a sign-up procedure of the possible information/service provider to connect with the user.

The request brokerage unit 15 may transfer the request of the user using an e-mail, an Internet messaging service, or a messaging service of a mobile communication system.

An operation of each component of the brokerage service system 10 may be understood from the descriptions related to the brokerage service method made with reference to FIG. 2.

A brokerage service using human networking via a brokerage service system according to an aspect of the present invention may be applicable in various types of fields. For example, the brokerage service may be used for various types of services such as an information search service, a reference recommendation service, a job offer/search service, a contents service, and the like.

Specifically, when the present invention is applied to the information search service, the brokerage service system may receive, from a user, a keyword associated with desired information and contact information of acquaintances that are likely to be aware of the desired information. Next, the brokerage service system may transfer an information request associated with the keyword to the acquaintances based on the contact information. Therefore, it is possible to transfer the information request to a possible information provider that can substantially provide the user with the information.

Also, when the present invention is applied to a job search service, the brokerage service system may receive, from a user, a resume and contact information of acquaintances that are likely to be aware of job offer information associated with a job the user is seeking. Next, when the request of the user is transferred based on the contact information and a positive answer is received from a person that is aware of the job offer information or that is finding an employee, the brokerage service system may connect the user with the person transmitting the positive answer. Through this, the brokerage service system may enable the user to find a desired job. Also, the present invention may be applied to a job listing service as is. In this case, the brokerage service system may receive, from a job offering company, job offer information and contact information and transfer the information to other people based on the contact information, subsequently connecting the job offering company with applicants. In the above-described brokerage service associated with job offer/search information, a brokerage service provider may receive a payment for the brokerage service from a party that requests the brokerage service for the job offer/search information, or may receive the payment from a party that provides the requested job offer/search information. Through this, the brokerage service provider may earn revenues. Also, by paying the possible information/service provider for providing information, it is possible to induce more active participation of possible information/service users and to activate the brokerage service.

As described above, according to the present invention, since a user's desired information or service can be relayed based on human networking, it is possible to quickly provide the user with the desired information or service and also improve reliability of the information or service.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A brokerage service method using human networking, the method comprising:
receiving, from a user, a request for information or service that the user desires and contact information of a first possible information/service provider;
transferring the request to the first possible information/service provider based on the contact information;
connecting the first possible information/service provider with the user when a positive answer is received from the first possible information/service provider in response to the request; and
repeatedly transferring the request to a second possible information/service provider every time contact information of the second possible information/service provider is received from the first possible information/service provider in response to the request.

2. The brokerage service method of claim 1, wherein the transferring of the request to the first possible information/service provider comprises automatically transferring the request via an automatic message transferring system that includes at least one of an electronic mail system, an instant messenger system, a messaging system of social network service, and a messaging system of a mobile communication system.

3. The brokerage service method of claim 1, further comprising:
receiving a payment for a brokerage service from the first possible information/service provider before connecting the first possible information/service provider with the user.

4. The brokerage service method of claim 1, further comprising:
performing a sign-up procedure of the first possible information/service provider before connecting the first possible information/service provider with the user.

5. The brokerage service method of claim 1, further comprising:
receiving a payment for a brokerage service from the user before connecting the first possible information/service provider with the user.

6. The brokerage service method of claim 1, further comprising:
paying the first possible information/service provider for when a positive answer is received from the second possible information/service provider in response to the request, and subsequently connecting the second possible information/service provider with the user.

7. A brokerage service system comprising:
a request receiver configured to receive, from the user, a request for information or service that a user desires;
a request brokerage unit configured to 1) obtain either contact information of a first possible information/service provider from the user or contact information of a second possible information/service provider from the first possible information/service provider, and 2) to transfer the request of the user based on the obtained contact information; and
a connection unit configured to connect, with the user, the first possible information/service provider or the second possible information/service provider that transmits a positive answer with respect to the request,
wherein the request brokerage unit is configured to repeatedly transfer the request to the second possible information/service provider based on contact information of second information/service provider every time the contact information of the second possible information/service provider is received from the first possible information/service provider in response to the request.

8. The brokerage service system of claim 7, further comprising:
a storage unit configured to store the request or brokerage information associated with the request.

9. The brokerage service system of claim 7, wherein the request brokerage unit is configured to automatically transfer the request via an automatic message transferring system that includes at least one of an electronic mail system, an instant messenger system, a messaging system of social network service, and a messaging system of a mobile communication system.

10. The brokerage service system of claim 7, further comprising:
a payment processor configured to receive a payment for a brokerage service from the user or the first possible information/service provider in association with a connection between the user and the first possible information/service provider.

11. The brokerage service system of claim 7, further comprising:
a payment processor configured to pay the first possible information/service provider for connecting the second possible information/service provider with the user.

12. The brokerage service system of claim 7, further comprising:
a sign-up register configured to perform a sign-up procedure of the first possible information/service provider or the second possible information/service provider to connect with the user.
